(19) United States
(12) Patent Application Publication
(10) Pub. No.: US 2023/0119303 A1
(43) Pub. Date: Apr. 20, 2023

(54) Protective and Communicative Face Mask

(71) Applicant: Hayden Matthews, D'abadie (TT)

(72) Inventor: Hayden Matthews, D'abadie (TT)

(21) Appl. No.: 18/045,849

(22) Filed: Oct. 12, 2022

Related U.S. Application Data
(60) Provisional application No. 63/256,687, filed on Oct. 18, 2021.

(51) Int. Cl. A62B 9/00; A62B 23/02; H04R 1/02; H04R 1/08

(52) U.S. Cl. CPC A62B 9/006; A62B 23/02; H04R 1/02; H04R 1/08

(57) ABSTRACT

The present invention relates to a face mask that protects the wearer from pathogens while enabling the wearer to be heard clearly, even at larger distances. The face mask can be a multilayered mask having a vent for expelling exhaled air and a combination of a microphone and a speaker for capturing and amplifying the sound of the wearer. Further, the face mask includes a temperature sensor for sensing the real-time temperature of the wearer, and an oxygen sensor for monitoring the blood oxygen level of the wearer. The temperature and the oxygen level can be transmitted to a paired software application installed in an electronic device for visualization and processing. The face mask amplifies the voice in situations where it is difficult to project same through the mask.

### CROSS-REFERENCE TO RELATED APPLICATION

The present application claims priority to, and the benefit of, U.S. Provisional Application No. 63/256,687, which was filed on Oct. 18, 2021, and is incorporated herein by reference in its entirety.

### FIELD OF THE INVENTION

The present invention relates generally to the field of face masks. More specifically, the present invention relates to a modified face mask integrated with a microphone, a Bluetooth speaker, vent and filter, and sensors such as a temperature sensor and an oxygen sensor in order to ensure the wearer is properly heard by others and is comfortable while wearing the mask. The face mask is a multi-layered mask that provides effective protection from pathogens and germs. Additionally, the face mask of the present invention comprises a miniature headphone jack to allow the use of the wired devices to amplify the voice in situations where it is difficult to project through the mask. The uniquely designed face mask enables teachers, presenters and others to clearly project their voice while maintaining safety by wearing the face mask in public places. Accordingly, the disclosure makes specific reference thereto. Nonetheless, it is to be appreciated that aspects of the present invention are also equally applicable to other like applications, devices and methods of manufacture.

### BACKGROUND

By way of background, various types of germs, viruses, bacteria and other harmful pathogens are present in the surroundings, which when inhaled by individuals, can be extremely dangerous for their health and may cause serious illness among the individuals. Additionally, in the event of a pandemic such as SARS or COVID-19, infectious diseases can easily transmit from one person to another and can affect large numbers of individuals around the world. Generally, individuals are advised to wear face masks to prevent the spread of infectious diseases. Standard face masks typically cover the nose and mouth of the individual in order to form a barrier between the surroundings and the nasal/oral passages of the individual. The face mask includes several layers of material that block the passage of germs and other contaminants. However, the use of multiple layers of material in face masks to provide enhanced protection against transmission of infectious diseases can block the air to pass through the mask as well, which causes the wearer to breathe uncomfortably. Even with the use of a single-layered face mask, individuals may be uncomfortable in breathing while wearing the mask for long periods of time, and may be urged to remove their mask to avoid suffocation, thereby causing risk of transmission of harmful pathogens, germs, viruses and more.

Additionally, use of conventional face masks at public places such as schools, hospitals, offices, etc., for a long period of time, can cause inconvenience to the wearers. Further, individuals can be hard to hear in situations where they try to speak while wearing the mask in public places. Individuals such as teachers, presenters or the like, may not be heard properly if they try to speak while wearing a mask. Individuals may have to either shout or speak loudly in order to be heard by others. A lot of effort is required in situations where a person is to give a presentation or have to speak continuously for a long period of time. It is not feasible for a person to continuously speak loudly while talking or instructing others. Also, individuals may get quickly exhausted in such loud conversations.

Therefore, there exists a long felt need in the art for a modified face mask that protects individuals against the transmission of harmful pathogens and the spread of infectious diseases, while ensuring the individual remains comfortable while wearing the face mask for a long period of time. There is also a long felt need in the art for an improved face mask that enables the users to be easily heard by others while wearing the protective face mask. Additionally, there is a long felt need in the art for a face mask that prevents individuals from taking off their masks for communicating with other individuals or while instructing others. Moreover, there is a long felt need in the art for a face mask that obviates the need to talk loudly to be heard by others in public places such as schools, offices or the like, and therefore prevents the wearer from becoming exhausted while communicating with other individuals. Further, there is a long felt need in the art for a face mask that enables the wearer to breathe comfortably while wearing the mask for a long period of time. Finally, there is a long felt need in the art for an improved face mask that enables teachers, trainers, presenters and others to project their voice while maintaining safety by wearing a protective face mask.

The subject matter disclosed and claimed herein, in one embodiment thereof, comprises an improved face mask designed to ensure that the mask wearer is easily heard when speaking, while ensuring safety from pathogens and germs. The face mask features an outer layer, a middle layer and an inner layer for providing protection to the wearer of the face mask from pathogens and germs. A microphone is included for capturing sounds of the wearer, a speaker for amplifying the sounds captured by the microphone and projecting same from the face mask, and an air vent for expelling out exhaled air. The face mask includes a nose guard having a temperature gauge for measuring a temperature of the wearer, and an oxygen sensor for measuring an oxygen level of the wearer.

In this manner, the novel face mask of the present invention accomplishes all of the forgoing objectives, and provides a relatively safe, easy and convenient solution to enable the wearers to project their voices to others while wearing the face mask. The face mask of the present invention is also user-friendly, as it does not require the users to speak loudly or shout to be heard by others and obviates the need to take off their masks while communicating with others. Additionally, the use of the face mask of the present invention enables ventilation and ensures a comfortable mask-wearing experience for the users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved face mask designed to ensure that the mask wearer is easily heard when speaking. The face mask further comprises an outer layer, a middle layer and an inner layer wherein the layers provide protection to the wearer of the face mask from pathogens and germs, a microphone for capturing sound of the wearer, a speaker for amplifying the sound captured by the microphone and projecting same from the face mask and an air vent for expelling out exhaled air. The face mask includes a nose guard having a temperature gauge for measuring the temperature of the wearer and an oxygen sensor for measuring the oxygen level of the wearer.

In a further embodiment of the present invention, the speaker and the microphone are concealed between the middle layer and outer layer and are not visually exposed to the exterior of the mask.

In yet another embodiment of the present invention, the vent is replaceable, acts as a filter and is preferably a one-way vent that can be closed when a wearer breathes in but is open when the wearer breathes out, thereby enabling the exhaled air to vent out easily.

In yet another embodiment, a protective and communicative face mask is disclosed. The face mask includes a directional antenna for capturing the sound and voice of a wearer of the face mask, a Bluetooth speaker for amplifying the captured sound for projecting same to enable others to hear the wearer clearly, a headphone jack for inserting a headphone, an internal battery for providing power to the speaker and the microphone, a micro-USB charging port for recharging the internal battery wherein the face mask can connect to a smartphone application installed in an electronic device for receiving and sending voice commands through a Bluetooth communication channel.

In yet a further embodiment, it is disclosed that the face mask includes a plurality of LED indicators wherein a first indicator indicates the functionality of the speaker and/or microphone, a second indicator indicates the level of blood oxygen of the wearer, and a third indicator indicates the temperature of the wearer. Further, the oxygen level and the temperature value can be transmitted to a paired face mask-monitoring software application.

In yet another embodiment of the present invention, an improved face mask integrated with a microphone and a speaker to enable effective communication while maintaining safety from airborne pathogens is disclosed. The face mask includes a microphone to pick up sound signals and the voice of the wearer of the face mask and a speaker to amplify the sound signals picked up by the microphone to increase the amplification of the sound signals such that the amplified sound signals are projected to a greater distance, thereby enabling others to hear the wearer even in crowded and noisy places.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a face mask with integrated communication system of the present invention in accordance with the disclosed architecture;

FIG. 2 illustrates a perspective view of one potential embodiment of the face mask with integrated communication system of the present invention in accordance with the disclosed architecture, wherein the face mask is being worn by a user;

FIG. 3 illustrates a perspective view of another potential embodiment of a face mask with integrated communication system of the present invention in accordance with the disclosed architecture;

FIG. 4 illustrates a diagrammatic view of the electronic components of one potential embodiment of the face mask with integrated communication system of the present invention in accordance with the disclosed architecture;

FIG. 5 illustrates a partial right side view of one potential embodiment of the face mask with integrated communication system of the present invention in accordance with the disclosed architecture;

FIG. 6 illustrates a partial left side view of one potential embodiment of the face mask with integrated communication system of the present invention in accordance with the disclosed architecture;

FIG. 7 illustrates a perspective view of one potential embodiment of the face mask with integrated communication system of the present invention in accordance with the disclosed architecture, wherein the face mask is connected to a mobile phone; and

FIG. 8 illustrates an enlarged sectional view of the face mask of the present invention showing the layers of the face mask in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not include all the aspects or advantages shown. Thus, in other embodiments, any of the features described herein from different embodiments may be combined.

As noted above, there exists a long felt need in the art for a modified face mask that protects individuals against the transmission of harmful pathogens and spread of infectious diseases, while ensuring the individual remains comfortable while wearing the face mask for a long period of time. There is also a long felt need in the art for an improved face mask that enables the users to be easily heard by others while wearing the protective face mask. Additionally, there is a long felt need in the art for a face mask that prevents individuals from taking off their masks for communicating with other individuals or while instructing others. Moreover, there is a long felt need in the art for a face mask that obviates the need to talk loudly to be heard by others in public places such as schools, offices or the like, and therefore prevents the wearer from becoming exhausted while communicating with other individuals. Further, there is a long felt need in the art for a face mask that enables the wearer to breathe comfortably while wearing the mask for a long period of time. Finally, there is a long felt need in the art for an improved face mask that enables teachers, trainers, presenters and others to project their voices while maintaining safety by wearing a protective face mask.

The present invention, in one exemplary embodiment, includes a novel protective and communicative face mask. The face mask includes a directional antenna for capturing the sound of a wearer of the face mask, a Bluetooth speaker for amplifying the captured sound and for projecting same, thereby enabling others to hear the wearer clearly, a headphone jack for inserting a headphone, an internal battery for providing power to the speaker and the microphone, and a micro-USB charging port for recharging the internal battery, wherein the face mask connects to a smartphone application installed in an electronic device for receiving and sending voice commands through a Bluetooth communication channel.

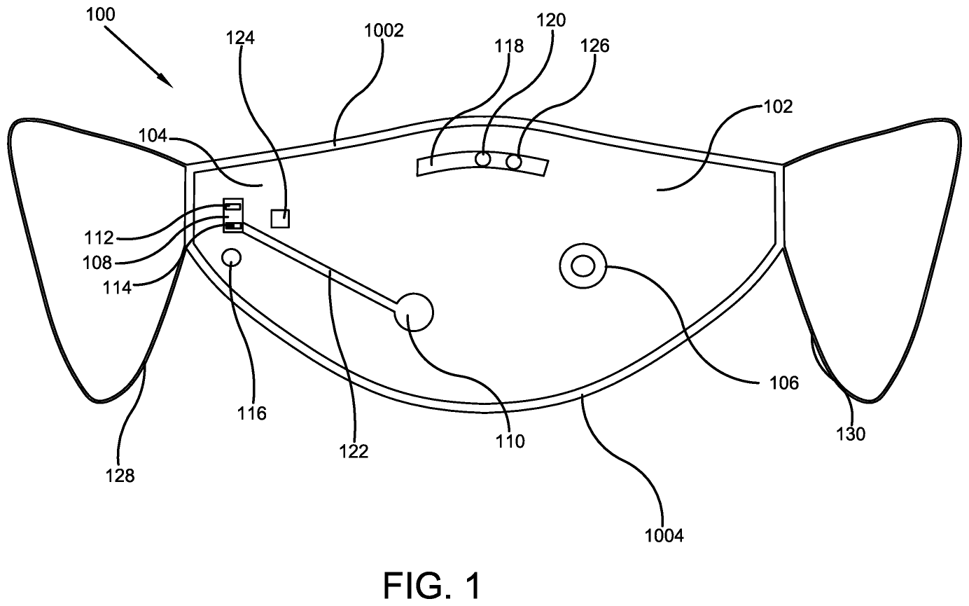

Referring initially to the drawings, FIG. 1 illustrates a front perspective view of one potential embodiment of an improved face mask of the present invention in accordance with the disclosed architecture. The face mask 100 of the present invention is designed to ensure that the mask wearer can be easily heard when speaking while wearing the face mask 100. The improved face mask 100 includes a shape and a size similar to a conventional face mask for providing proper protection against pathogens such as Covid-19, SARS, germs, viruses and other microbes. The face mask 100 can include a pair of ear loops 128, 130 for engaging to the right ear and left ear respectively, of the wearer. Further, the face mask 100 spans from the top edge 1002 to the bottom edge 1004, and is designed to cover the mouth and nose of the wearer. The face mask 100 can include a plurality of layers, wherein the layers made can be made from one or more of twill fabric, cloth or polypropylene fiber to maintain protection against harmful airborne pathogens. In one potential embodiment, the face mask 100 can include three layers of fabric having an inner layer of an absorbent material such as a cotton, a middle layer of a non-woven non-absorbent material such as a polypropylene, and an outer layer of a non-absorbent material such as a polyester or a polyester blend. The face mask 100 can be arranged in a variety of sizes and colors and is configured to fit comfortably to a wearer.

More specifically, the face mask 100 includes a left portion 102 for covering a left portion of the face of the wearer and a right portion 104 for covering a right portion of the face of the wearer. In the present embodiment, the left portion 102 includes a built-in replaceable vent or filter 106 that provides easy and comfortable breathing while wearing the mask 100. Also, the replaceable vent 106 filters out the smallest particles, germs and microbes from the air. The vent 106 is preferably a one-way vent that is closed when a wearer breathes in, but is open when the wearer breathes out, thereby enabling the exhaled air to vent out easily.

The right portion 104 includes a built-in concealed speaker 108 for playing out the sound uttered by the wearer wearing the face mask 100. The right portion 104 includes a microphone 110 connected internally to the speaker 108 through a wired mechanism 122. The microphone 110 is disposed and positioned in the face mask 100, such that it is positioned near the mouth of the wearer when the face mask 100 is worn by a wearer. The microphone 100 captures the sounds uttered by the wearer, and the speaker 108 connects to the microphone 110 and amplifies the sound so that other individuals can hear the sound loudly and clearly and the communication is thus not obstructed by the face mask 100. The power or decibel level of the sound can be amplified by the speaker 108. The speaker 108 includes a toggle switch button 112 for turning on and off the speaker 108. The face mask 100 includes a mini-USB charging port or a USB charging port 114 for recharging a built-in flexible battery 124. The battery 124 provides power to both the microphone 110 and the speaker 108. The microphone 110 can be placed near the bottom of the right portion 104, such that the microphone 110 easily picks up the sound and voice generated by the user wearing the mask 100.

The face mask 100 can be integrated with a miniature headphone jack 116 that enables a wearer of the mask 100 to connect to a wired device such as a headphone, an earpiece or any other such type of wired device with the speaker 108 and/or microphone 110.

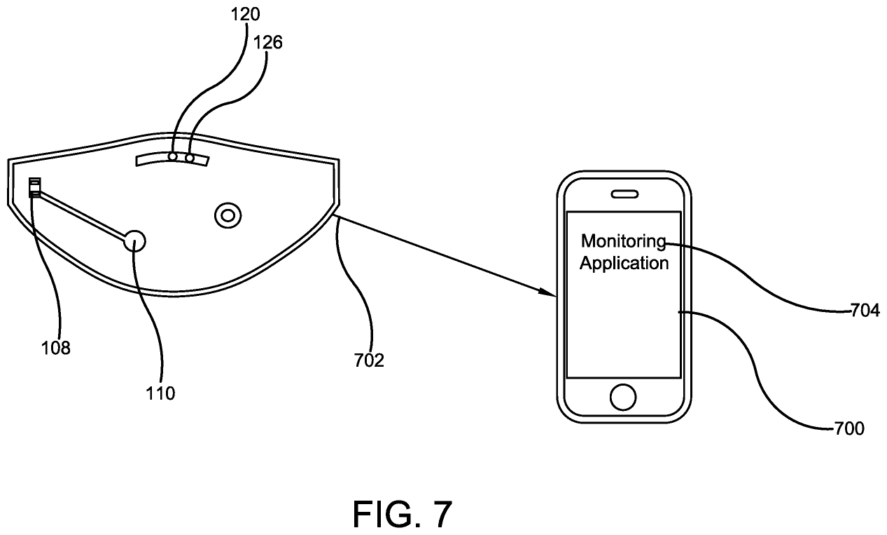

The face mask 100 of the present invention includes a nose guard 118 that enables the top edge 1002 of the face mask 100 to adhere to the face. The nose guard 118 can be in the form of a wire that contours to the bridge of the nose of the wearer. The nose guard 118 includes an integrated temperature gauge 120 that monitors the temperature of the wearer of the mask 100. In one embodiment, the temperature gauge 120 can provide the real-time body temperature of the wearer to a mask monitoring software application installed in an electronic device. Further, the face mask 100 includes an oxygen sensor 126 for sensing the oxygen level of the wearer, and is configured to position near the nose of the wearer. The real time oxygen level of the wearer can be transmitted to the mask monitoring software application as best shown in FIG. 7.

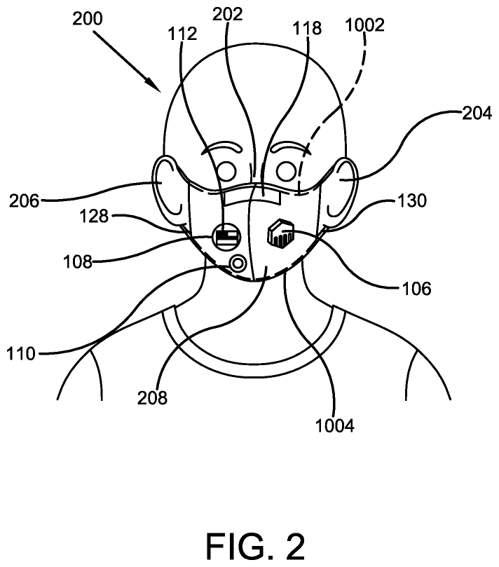

FIG. 2 illustrates a perspective view of a user wearing the improved face mask of the present invention in accordance with the disclosed architecture. As shown, a user 200 wears the improved face mask 100 of the present invention in a manner similar to a conventional face mask. The upper seam/top edge 1002 of the face mask 100 covers the nose 202 and cheek bones of the user 200, such that the nose guard 118 is placed over the nose 202. The bottom edge 1004 of the face mask 100 covers the mouth 208 of the user 200. The left ear loop 130 engages with the left ear 204 and similarly, the right ear loop 128 engages with the right ear 206. The placement of the speaker 108 and the microphone 110 on the face mask 100 is such that they are positioned near the lips of the user 200 while wearing the mask, such that the microphone 110 picks up the sound made by the user 200 and passes same onto the speaker 108. The speaker 108 amplifies the sound and projects same around the user 200 in an amplified manner, thereby enabling others to easily and clearly hear the wearer of the mask 100 even in a noisy environment. The microphone 110 can include a minute directional antenna for picking up the sound uttered by the wearer 200. The speaker 108 can also include a noise cancellation means that helps in projecting an amplified and clear voice around the user 200.

User 200 can use the toggle button 112 to manually turn on/off the speaker 108 to save the internal battery of the face mask 100. The wearer 200 can communicate easily with the public while wearing the face mask 100 using the microphone 110 and the speaker 108, thus facilitating effective communication while maintaining the safety of the wearer from airborne pathogens. The vent 106 provides an easy path for the exhaled air, and thus provides a convenient usage of the face mask 100 for long periods of time.

It should be appreciated that all the electronic components of the face mask 100 are concealed within the body of the mask 100, and thus are not visible on the exterior layer of the face mask 100. The components can be disposed between the outermost layer and the middle layer of the face mask 100. Further, the speaker 108, microphone 110, battery 124, wired circuit 122 and all other components are flexible and machine washable.

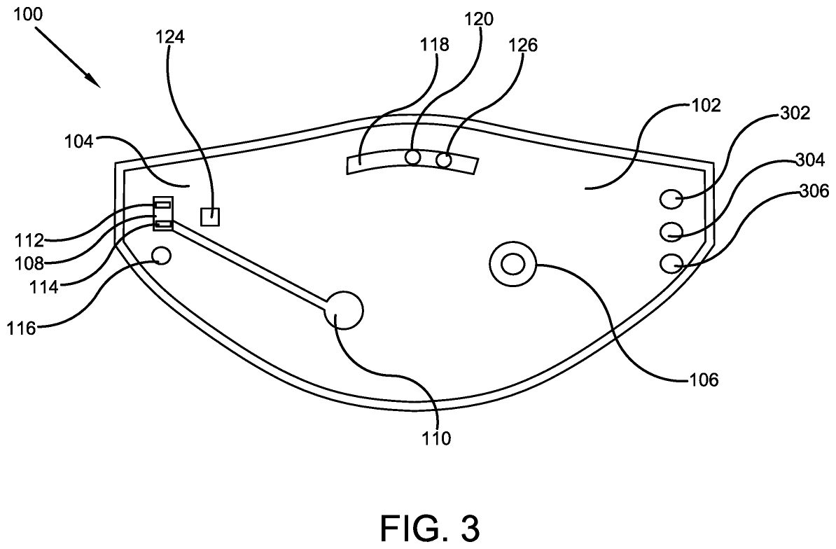

FIG. 3 illustrates a perspective view of another embodiment of improved face mask of the present invention having visual indicators in accordance with the disclosed architecture. It should be noted that all the components required for functionality of the face mask 100 of FIG. 1 can work in the same manner in the LED-enabled face mask 300 of the present embodiment. The LED-enabled face mask 300 is integrated with LED indicators that are automatically illuminated to indicate the status of the face mask 300 to provide information about the wearer of the mask 300. When the wearer turns on the toggle button 112 of the speaker 108, the LED indicator 302 is illuminated, indicating that both the speaker 108 and the microphone 110 are operational. The face mask 300 is also integrated with a temperature LED indicator 304 that illuminates when the temperature gauge 120 detects a high temperature of the wearer of the mask 300. In cases where the temperature of the wearer is more than 99 degrees Fahrenheit, the temperature LED indicator 304 is illuminated. The face mask 100 can also be integrated with an oxygen level indicator 306 that illuminates when the oxygen sensor detects a low oxygen level of the wearer of the mask 300.

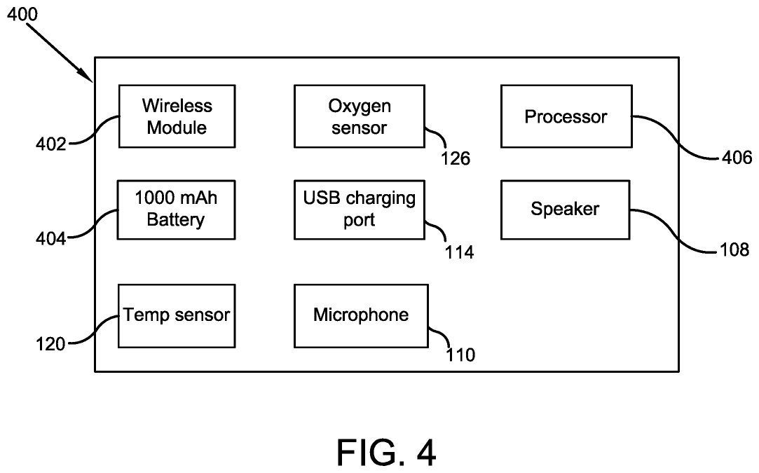

FIG. 4 illustrates a block diagram showing components of the improved face mask of the present invention in accordance with the disclosed architecture. The face mask 100 includes an internal battery 404 that can be in the form of a button battery concealed in the face mask 100 and can provide a power source such as 820 mAh or 1000 mAh. The battery 100 can be coupled with the microphone 110, the speaker 108 and the USB charging port 114. Both the speaker 108 and the microphone 110 are also connected to each other internally using the wired circuit. In one embodiment, the speaker 108 can be a Bluetooth speaker that connects to any electronic device or consumer device through a wireless channel established by the wireless module 402. The wireless module 402 can be designed to provide a wireless channel, preferably a low energy Bluetooth channel.

The USB-charging port 114 can be used for recharging the button battery 404 of the face mask 100. A power source such as a power bank can be used for recharging the button battery 404. The integrated temperature sensor 120 detects the real-time body temperature of the wearer of the mask 100. The temperature sensor 120 measures the temperature of the wearer with an accuracy of ±2° F. The face mask 100 includes an oxygen sensor 404 that monitors the oxygen level of the wearer of the mask 100. More precisely, the oxygen sensor 126 measures the oxygen concentration in the blood of the wearer with a minimum deviation of +/−1%. A processor/controller 406 acts as the controlling component to send controlling instructions to different components of the face mask 100.

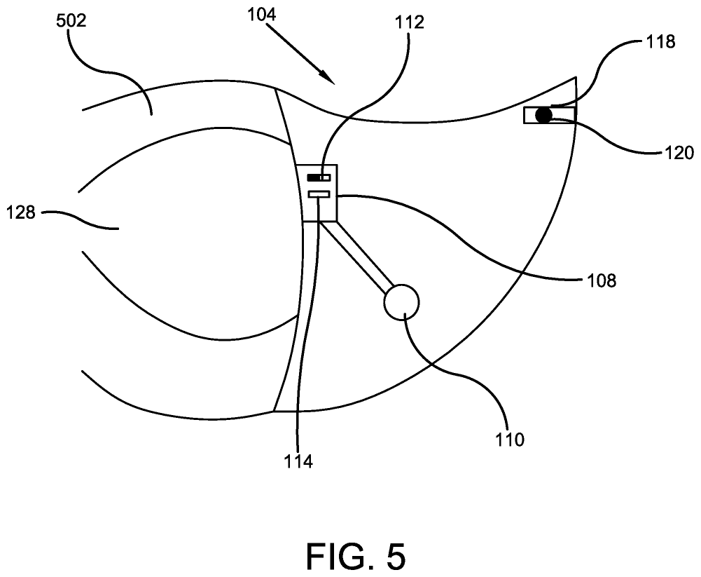

FIG. 5 illustrates a right portion perspective view of the improved face mask of the present invention in accordance with the disclosed architecture. As shown in FIG. 5, the right portion 104 of the face mask 100 is disposed with a built-in speaker 108 to emit the sounds made by the user wearing the face mask 100. The right portion 104 includes a microphone 110 connected to the speaker 108. The microphone 110 captures the sound of the user wearing the mask 100 and the speaker 108 connected to microphone 110 amplifies the sound, so that other individuals can hear the sound loudly and clearly. The speaker 108 includes a mini-USB charging port or a USB charging port 114 and a toggle switch button 112 to turn on/off the speaker 108. The microphone 110 is placed near the bottom of the right side 104, such that the microphone 110 easily picks up the sounds generated by the user wearing the mask 100.

The right side 104 includes a right ear loop 128 that engages with the right ear of the wearer. The face mask 100 can include a hook and loop strap 502 that is adjustable, and gives full coverage to the mouth and nose of the wearer wearing the mask 100. The hook and loop strap 502 can adhere to the back of the head for providing additional security to the face mask 100. The right side 104 includes a nose guard 118 that prevents the fogging of glasses worn by the wearer and also prohibits air from passing through the top edge. The nose guard 118 is integrated with the temperature gauge 120 that monitors the temperature of the wearer of the mask 100. In one embodiment, the temperature gauge 120 can provide the real-time body temperature of the wearer of the mask and transmit same to a monitoring software application installed in the electronic device.

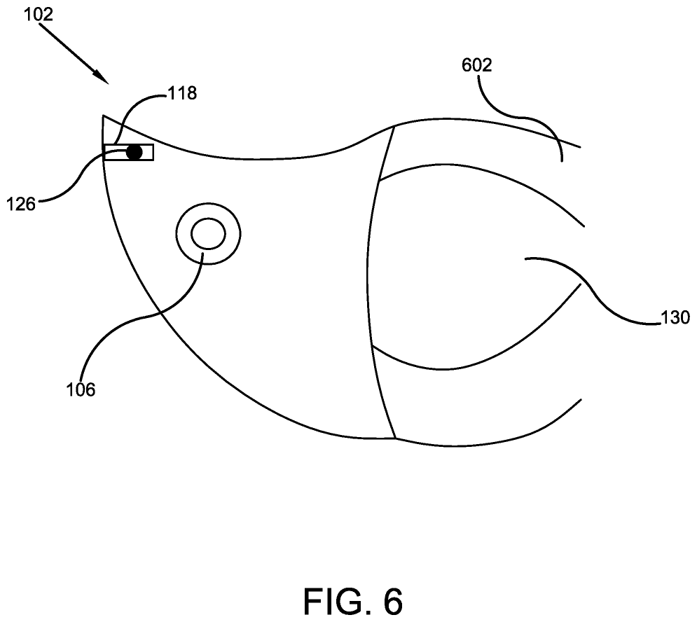

FIG. 6 illustrates a left portion perspective view of the improved face mask 100 of the present invention in accordance with the disclosed architecture. The left portion 102 of the face mask 100 includes an integrated and replaceable vent 106 that provides easy and comfortable breathing while wearing the mask 100. The replaceable vent 106 filters out the smallest particles in the air. The left portion 102 includes a left ear hole 130 that engages with the left ear of the wearer. The face mask 100 includes a left side hook and loop strap 602 that is adjustable, and gives full coverage to the mouth and nose of the wearer wearing the mask 100. The hook and loop strap 602 can adhere to the back of the head for providing additional security to the face mask 100. The left portion 102 includes a portion of the nose guard 118 having the oxygen sensor 126 for measuring the oxygen level in the blood of the wearer.

FIG. 7 illustrates a perspective view showing a wireless connection between the face mask 100 of the present invention and an electronic device 700 having a monitoring application 704 in accordance with the disclosed architecture. As described supra, the face mask 100 can include a wireless module that enables a user to establish a wireless connection 702 with an electronic device 700 such as a mobile device. The electronic device 700 can include a face mask monitoring application 704 for displaying the oxygen level and temperature of the wearer received from the oxygen sensor 126 and the temperature sensor 120, respectively. The Bluetooth connection can also be used to connect the speaker 108 to the electronic device 700. Once the Bluetooth speaker 108 is connected to the electronic device 700, the sound signals captured by the microphone 110 can be transferred to the smartphone 700 through the communication channel 702. Also, voice from the electronic device 700 can be played out on the speaker 108 wherein the voice signals are received from the electronic device 700 using the wireless communication channel 702.

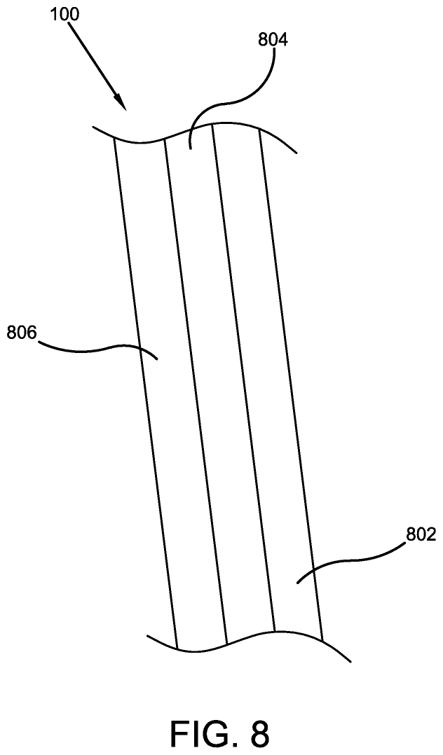

FIG. 8 illustrates an enlarged sectional view of the face mask 100 of the present invention showing the layers of the face mask 100 in accordance with the disclosed architecture. The face mask 100 includes an exterior or outer layer 802 of a non-absorbent and water-resistant material, such as polyester or a polyester blend. The outer layer 802 can be Hydrophilic-spun bond 20-100 grams per square meter (GSM) fabric. The electronic components such as the speaker 108, the microphone 110 and the battery can be disposed between the outer layer 802 and the middle layer 804. The middle layer 804 can be made from 10-50 GSM of spun bond fabric. The interior or inner layer 806 can be made from 5-40 GSM of spun bound absorbent material or fabric that absorbs sweat and enables the wearer to wear the mask for a longer duration. The mask 100 provides a snug fit around the face of the wearer with the ear loops securing the mask around the ears of the wearer. In one potential embodiment, the outer layer includes 40-45 GSM fabric, the middle layer includes 10-30 GSM fabric and the inner layer includes 10-15 GSM fabric.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved face mask”, “mic integrated face mask”, “face mask”, “mask” and “Bluetooth face mask” are interchangeable and refer to the Bluetooth face mask 100,300 with the integrated speaker and microphone of the present invention.

Notwithstanding the forgoing, the Bluetooth face mask 100, 300 with integrated speaker and microphone of the present invention can be of any suitable size and configuration as is known in the art without affecting the overall concept of the invention, provided that it accomplishes the above-stated objectives. One of ordinary skill in the art will appreciate that the size, configuration and material of the Bluetooth face mask 100, 300 with the integrated speaker and microphone as shown in the FIGS. are for illustrative purposes only, and that many other sizes and shapes of the Bluetooth face mask 100, 300 with the integrated speaker and microphone are well within the scope of the present disclosure. Although the dimensions of the Bluetooth face mask 100, 300 with the integrated speaker and microphone are important design parameters for user convenience, the Bluetooth face mask 100, 300 with the integrated speaker and microphone may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective mask configured to provide a protective barrier to a face of a user, the protective mask comprising:
a mask portion having multi-layers including an outer layer, a middle layer, and an inner layer;
a microphone for receiving voice sounds of a wearer of said mask; and
a speaker for amplifying said voice sounds of the wearer of said mask, wherein said inner layer includes an absorbent material, said middle layer includes a non-absorbent material, and said outer layer includes a non-absorbent material, and further wherein said microphone and said speaker are disposed between said outer layer and said middle layer.

2. The protective mask of claim 1 further comprising a built-in vent passing through said outer layer, said middle layer, and said inner layer, wherein said vent is a one-way vent that closes when a wearer breathes in and opens when the wearer breathes out enabling exhaled air to vent out.

3. The protective mask of claim 2, wherein said vent is replaceable and includes a filter for filtering particles, germs and microbes.

4. The protective mask of claim 2, wherein said speaker further comprises a Bluetooth connection for wireless connection to an electronic remote device.

5. The protective mask of claim 4, wherein said face mask further comprises a battery for providing power to said speaker and said microphone.

6. The protective mask of claim 5, wherein said face mask further comprising a USB charging port for recharging said battery.

7. The protective mask of claim 2 further comprising a Bluetooth connection for wireless connection to a smartphone application installed in an electronic device.

8. The protective mask of claim 2, wherein said middle layer is a polypropylene having a 10-50 GSM.

9. The protective mask of claim 8, wherein said outer layer is selected from a group consisting of a polyester and a polyester blend having a 20-100 GSM.

10. The protective mask of claim 9, wherein said inner layer is a 5-40 GSM fabric.

11. The protective mask of claim 2, wherein said middle layer is a polypropylene having a 10-30 GSM.

12. The protective mask of claim 11, wherein said outer layer is selected from a group consisting of a polyester and a polyester blend having a 40-45 GSM.

13. The protective mask of claim 12, wherein said inner layer is a 10-15 GSM fabric.

14. A protective mask configured to provide a protective barrier to a face of a user, the protective mask comprising:
a mask portion having multi-layers including an outer layer, a middle layer, and an inner layer;
a microphone for receiving voice sounds of a wearer of said protective mask;
a speaker for amplifying said voice sounds of the wearer of said protective mask;
a temperature sensor for monitoring a temperature of the wearer of said protective mask; and
an oxygen level sensor for monitoring a blood oxygen level of the wearer of said protective mask.

15. The protective mask of claim 14, wherein said inner layer comprises an absorbent material, said middle layer comprises a non-absorbent material, and said outer layer comprises a non-absorbent material, and further wherein said microphone and said speaker are disposed between said outer layer and said middle layer.

16. The protective mask of claim 14, wherein said speaker further comprises a Bluetooth connection for wireless connection to an electronic remote device.

17. The protective mask of claim 14 further comprising a battery for providing power to said speaker and said microphone.

18. The protective mask of claim 17 further comprising a USB charging port for recharging said battery.

19. A protective mask configured to provide a protective barrier to a face of a user, the protective mask comprising:
a mask portion having multi-layers including an outer layer, a middle layer, and an inner layer;
a microphone for receiving voice sounds of a wearer of said protective mask;
a speaker for amplifying said voice sounds of the wearer of said protective mask;
a temperature sensor for monitoring a temperature of the wearer of said protective mask; and
an LED indicator for indicating when the temperature is above a predetermined temperature.

20. The protective mask of claim 19 further comprising a battery for providing power to said speaker, said microphone, and said LED indicator.
